(19) United States
(12) Patent Application Publication
(10) Pub. No.: US 2011/0106658 A1
(43) Pub. Date: May 5, 2011

(54) INTERNET PORTAL FOR MORTGAGEE/RENTER PASS-THROUGH SUBSCRIPTION

(76) Inventor: Barry Britt, Suwanee, GA (US)

(21) Appl. No.: 12/609,161

(22) Filed: Oct. 30, 2009

(51) Int. Cl. G06Q 30/00

(52) U.S. Cl. 705/26.25

(57) ABSTRACT

An internet portal for connecting prospective renters and property owners/managers provides features for further managing an on-going relationship between renters, property owners/managers and other parties such as mortagees. An agreement may be entered into via the portal that arranges rent on a property to be paid in a pass-through arrangement directly to the mortgagee, avoiding potential foreclosures of which a renter might be otherwise unaware. A rating system is provided by which performance of renters and the performance of the property owners/managers may be evaluated during the relationship and used to inform others as historical and comparative data.

### BACKGROUND OF THE INVENTION

1. Field of the Invention

The present invention relates generally to real estate property management and contracts, and more specifically, to an Internet portal that provides for connection of renters with landlords in a pass-through subscription agreement.

2. Background of the Invention

Internet portals have been provided for renters to locate available properties, and as such, serve as searchable alternatives to traditional property search methods such as local weekly or monthly rental brochures and classified advertisements in newspapers. Property owners or property managers list their property's availability, price and other information, and prospective renters can search or browse to find suitable properties matching their needs.

Once the property has been located, communication proceeds via the contact information provided in the listing, e.g., via telephone, e-mail in-person meeting at a rental office, and so forth. Therefore, the use of the rental Internet portal typically ends with the locating of the properties.

Since the use of the portal typically ends after location of a property, there is no incentive to provide on-going services that may be of use to the renters, property owners and property managers.

Therefore, it would be desirable an Internet portal for managing or otherwise facilitating on-going relationships between renters, property owners, property managers and other interested parties using an Internet portal or other networking facility that provides connectivity to each of interested parties.

### SUMMARY OF THE INVENTION

The above objectives of facilitating on-going relationships between renters, property owners, property managers and other interested parties is achieved in a method, a system and a computer program product. The computer program product is a program for carrying out the steps of the method and the system is a networked computer system that also carries out the steps of the method.

The method implements an Internet site serving a portal that permits property owners/managers to list rental properties available for rent, and for prospective renters to locate the properties. The portal further manages an on-going relationship between the renter and at least one other party, in according to various embodiments of the present invention. A pass-through payment arrangement with a mortgagee of a property may be arranged and managed through the portal, such that an agreement is entered into whereby the renter pays rent directly to the mortgagee, with any excess credited to the property owner. An electronic contact form can be executed at the portal by the property owner and the renter.

In accordance with another embodiment of the invention, a rating system is provided by the portal by which the renters performance as a payer, and also their behavior as a tenant can be rated by the property owner/manager and a property owner's performance in maintaining the property out of foreclosure and any other issues raised by the renter may be used to rate the property owner/manager.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting a networked computer system in which an embodiment of the invention is practiced.

FIG. 2 is a flowchart depicting operation of a networked computer system in accordance with an embodiment of the invention.

FIG. 3 is a flowchart depicting operation of a networked computer system in accordance with another embodiment of the invention.

FIGS. 4-7 are pictorial diagrams depicting user interface screens within a networked computer system in which an embodiment of the invention is practiced.

### DETAILED DESCRIPTION OF THE PREFERRED EMBODIMENTS

The present invention encompasses methods, networked computer systems and computer programs that implement a network portal, such as an Internet site, that provides interaction between prospective renters, property owners or owner's agents (e.g., property managers) and in some embodiments, a mortgagee of the property. Particularly in high foreclosure rate climates, it is desirable for both the renter, i.e., the tenant of a property and the mortgagee, i.e., the party that made the loan secured by the property, to ensure that mortgage payments are made in a timely manner, so that renters are not unexpectedly faced with eviction when a property owner has not been making mortgage payments. The system may provide a financial intermediary service, or may interface with an external financial services provider to accept rent payments, apply the rents to mortgages, and pay or escrow any remainder to the property owner or assess any shortages to the property owner.

In general, the business model supported by the Internet portal of the present invention may be supported by interest floats occurring between receipt of rent payments and application of those payments to obligations to the mortgagee and/or fees collected as a flat rate or percentage of the funds that are being accepted from a renter, and then paid to a mortgagee. Alternatively, such a structure may be supported by a membership fee. If the portal is supported by interest floats, then the system will definitely collect the rental amounts from tenants, hold the rents and then apply the rents as the mortgage payments come due. Additional escrow funds provided from the owner can be used to make up for any shortage in the mortgage payments over the rents and any processing fees, and the interest on the escrowed funds used to support the business model of the entity that owns the Internet portal.

The portal provides transparency to the process of ensuring that mortgage payments are made on time and in the proper amounts by providing secure logins and view of the payment and event history, e.g., the status of the mortgage to both the renter and the owner. The mortgagee may also have access to verify that payments acknowledged by the system have not been misdirected. The portal also provides information and/or ratings on renters, property owners and/or properties, which may be based on ongoing information such as whether the renter is timely on rent payments and whether a property owner is timely on making mortgage payments, but may also accept commentary input made by the various parties as the tenant relationship proceeds. Therefore, the present invention provides on-going tracking and maintenance of the relationship between the landlord, the tenant and the mortgagee during the term of that relationship, rather than merely initiating the relationship. In accordance with an embodiment of the invention, the portal directs payment from the renter to the mortgagee, and such “directing” is generally accomplished with electronic fund transactions (EFTs) that are initiated and otherwise automated via the portal, but could be traditional funds transactions that are later verified by the mortgagee, which causes the portal's history and status to update in response. However, as an alternative, the portal can serve as a tracking facility without including the automated financial transaction management features, in which case the funds are “directed” by the pass-through agreement initiated by the Internet portal, while the actual periodic payments are made off-line.

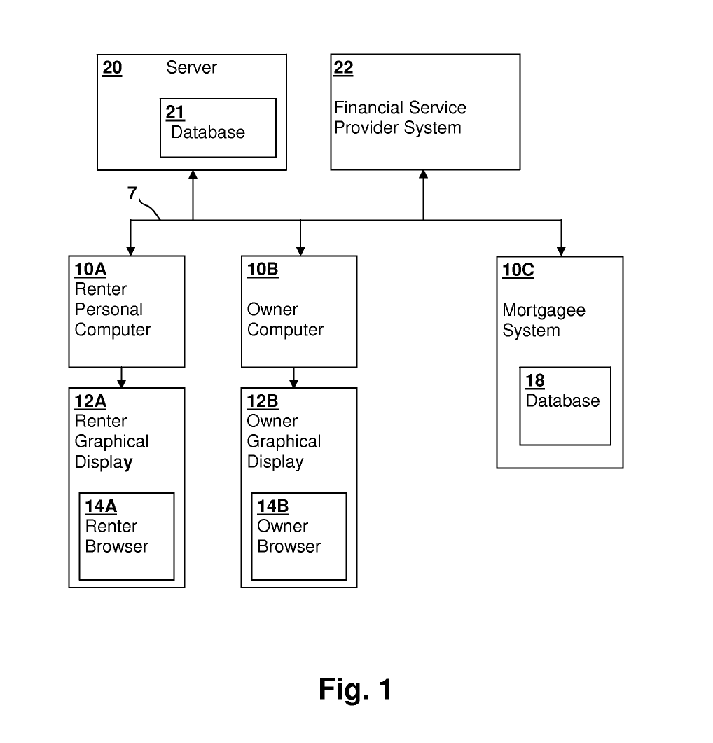

Referring now to FIG. 1, a networked computer system in accordance with an embodiment of the present invention is shown. A web server 20 is connected to a network 7 such as the Internet, to multiple other systems, including, for purposes of illustration, a renter personal computer 10A, a property owner's computer 10B a computer system 10C at a mortgagee, such as a large lending institution, and a financial service provider's system 22. The connections shown are only illustrative of a basic system in which the invention may be practiced, and it is understood that server system 20 may comprise a large scale system having processing systems distributed across multiple locales, and that network 7 may include multiple different types of wireless and or wired network links in order to interconnect the various systems used by the various parties that are involved in practicing the techniques of the present invention.

Server 20 contains a database 21, which in the illustrative example, includes electronic contract forms, communications structures for communicating with the various parties, rental listings, data structures describing executed rental agreements and mortgage pass-through agreements, along with other information needed to practice the various embodiments of the invention as illustrated herein. It is understood that all or portions of database 21 may be located external to server 20 as well, and may be a distributed database having information stored at multiple locations. The connection to financial service provider system 22 is optional, and the financial services provided between the mortgagee, renters and property owners may be implemented by a fully-integrated portal in accordance with an embodiment of the present invention, without requiring connection to a separate financial service provider system. However, such a fully-integrated portal will still generally access providers for electronic funds transactions (EFTs) and card services so that electronic exchanges of funds may be made between the parties.

Renter personal computer 10A is coupled to or includes a graphical display 12A on which screens of a browser 14A executing within rental personal compute 10A are displayed. Browser 14A is used to interact with programs executing within server 20 that manage the rental relationships, collect data and act on user input received from browser 14A and provide information to be displayed by browser 14A. While the above describes a client-server model, client-server architecture is not a requirement of the present invention and it is understood that program code that implements the present invention may be distributed among servers and workstations as appropriate for the particular implementation(s) of the present invention. Property owner computer 10B also is coupled to or includes a graphical display 12B on which screens of a browser 14B executing within owner's computer 10B are displayed. Browser 14B also is used to interact with the programs described above. However, the interfaces for a property owner will differ from those provided to a renter or prospective renter as described in further detail below. Mortgagee computer system 10C contains a database 18 that maintains information on the various pass-through relationships maintained by the portal provided by programs executing within server 21. Mortgagee computer system 10C and may also be coupled to workstations and displays for interacting with server 20 to accept payments, update survey information for use in renter/owner rankings, execute pass-through agreements and otherwise interact with the portal provided by server 21 as needed to implement the techniques of the present invention.

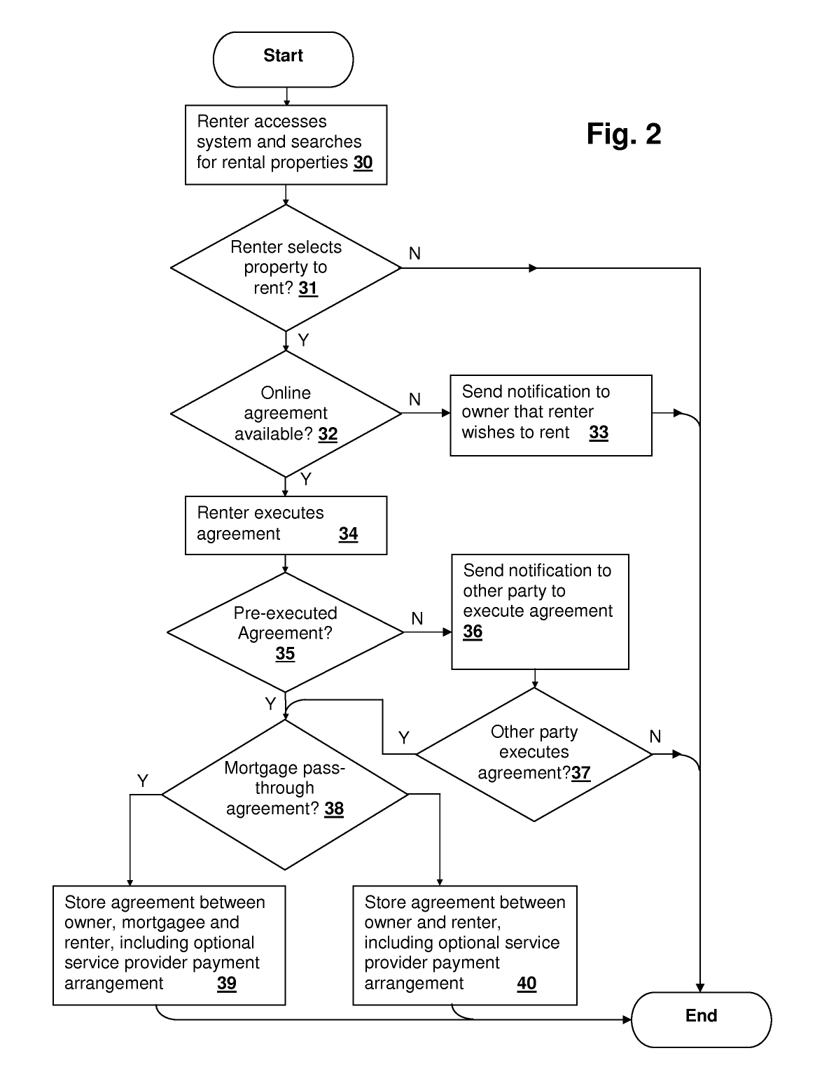

Referring now to FIG. 2, a method according to an embodiment of the present invention is illustrated. First, a renter accesses the system and searches for rental properties (step 30). If the renter selects a property to rent (decision 31), if an on-line agreement is not available (decision 32), then the property owner (or the owner's agent) is notified that the renter wishes to rent. If an on-line agreement is available (decision 32) the system proceeds to initiate a rental agreement by having the renter execute the agreement (step 34). If the agreement is not pre-executed from the other parties (decision 35), then a notification is sent to the other party/parties to execute the agreement (step 36). For example, the property owner and the mortgagee may be required to approve a renter for a pass-through agreement. In other arrangements, the agreement may have to be ratified only by the property owner, or only by the a mortgagee. If the other party executes the agreement (decision 37), then the contract is made, and if the agreement is a pass-through agreement (decision 38) the agreement between the owner mortgagee and renter is stored, and optionally a payment arrangement is set-up either in the system, or through communication with financial services provider 22. If the agreement is not a mortgage pass-through agreement (decision 38), then the system stores the agreement between the owner and the renter and also may provide a payment arrangement with financial services provider 22 or an internal financing arrangement (step 40).

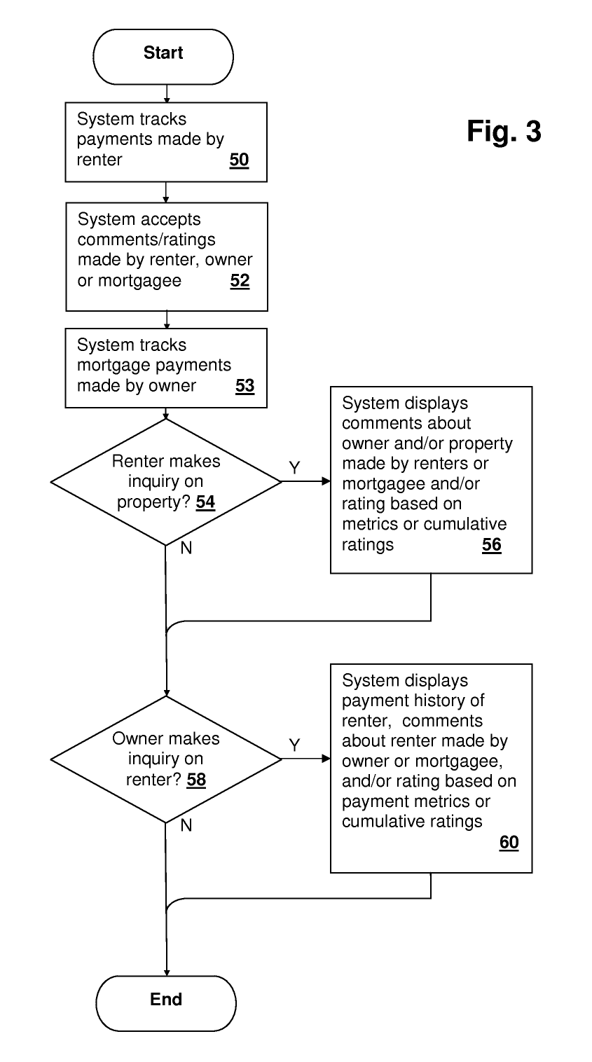

Referring now to FIG. 3, a method according to an embodiment of the present invention is illustrated. The method of FIG. 3 may be practiced in conjunction with the method of FIG. 2, or may be implemented in another system that includes only some of the features of the method depicted in FIG. 2. In the method of FIG. 3, the system (portal) tracks payments made by the renter (step 50) and accepts comments and/or ratings made by the renter, owner or mortgagee (step 52). If the agreement is not a pass-through agreement or the rent is less than the mortgage payment, the system may also track the mortgage payments made by the owner (step 53). When a renter makes an inquiry on a property (decision 54), the system displays comments about the owner and/or the property made by previous/existing renters or by a mortgagee. The system may alternatively or additionally display a rating value or other indicator, such as a color, indicating a rating based on the collected metrics or cumulative ratings made by renters and/or mortgagees (step 56). When a property owner or mortgagee makes an inquiry about a renter (decision 58), the system displays the payment history of renter, comments about the renter made by property owners or mortgagees, and/or ratings based upon payment metrics or cumulative ratings from other property owners and/or mortgagees (decision 60).

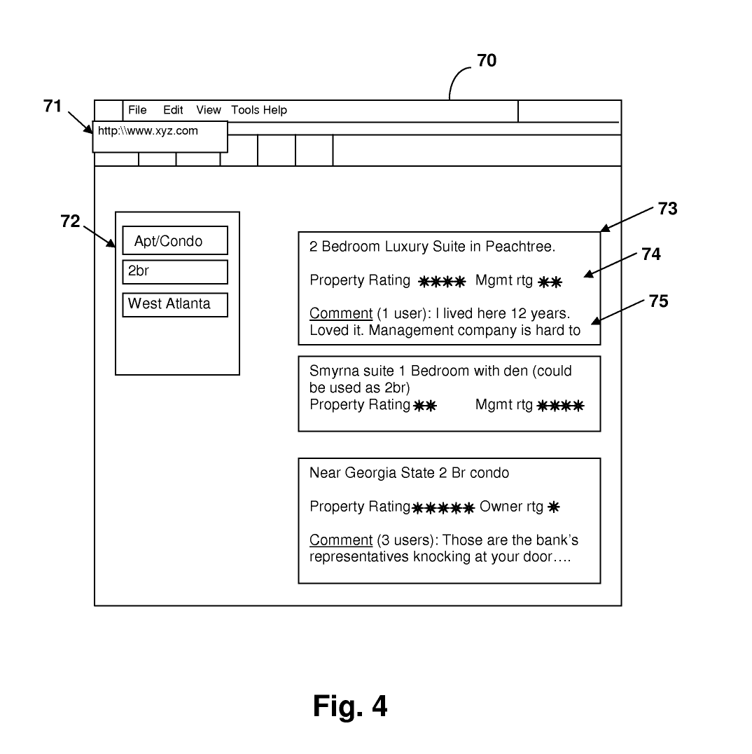

Referring now to FIG. 4, an output display 70 of a browser of a prospective renter such as browser 14A of FIG. 1 is shown. The browser is pointed to a uniform resource location (URL) of the Internet portal described above. A search criteria input interface 72 permits textual or control (e.g., drop-down) input to set criteria for finding prospective rental properties. Listings 73 of matching properties are displayed in response to the search. Listings 73 include information 74 about previous or on-going rental relationships of the property owner and information/ratings 74 about the property itself. The rating of the property owner may be accumulated across multiple properties, whereas the property rating is based on the property itself, and might accrue across multiple owners or property managers, since management companies could be changed or properties transferred. Comments 75 can also be provided by previous renters or, in some cases, mortgagees.

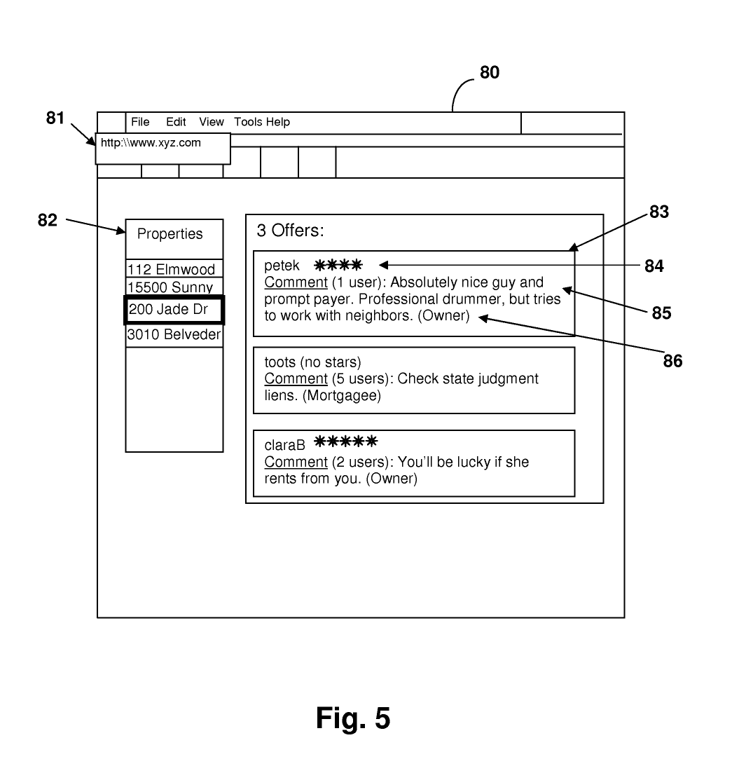

Referring now to FIG. 5, an output display 80 of a browser of a property owner or property manager such as browser 14B of FIG. 1 is shown. The browser is pointed to a uniform resource location (URL) of the Internet portal described above. A property listing box 82 lists all of the properties for the user, who may be a property manager managing large numbers of rental properties. Offers 83 from prospective renters are shown in embodiments of the invention in which pre-executed agreements are not provided from the owner/mortgagee, or in which the rating of the prospective renter is not high enough for the system to automatically provide an offer from the owner and mortgagee to a prospective renter. Ratings 84 of the prospective renters are provided based on input from previous owners or property managers, along with comments 85, and indications 86 of the status of the commentator, such as whether the commentator is the mortgagee, the property owner/owner's agent. The ratings 84 and comments 85 are accumulated during previous leases entered into by the renter for other properties, including the present property.

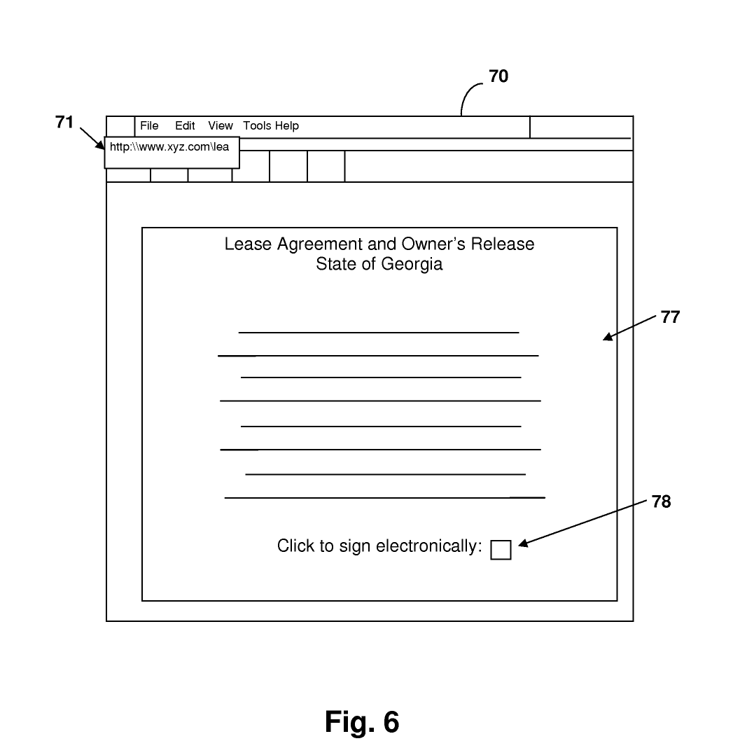

Referring now to FIG. 6, output display 70 of the browser of the prospective renter is shown with the browser directed to an electronically-executable agreement 77 that binds the prospective renter (and on an owner/agent/mortgagee screen, the other party if a pre-executed agreement is not provided by the system). The electronic agreement contains the text of the agreement, along with prompts to the viewer to read all of the agreement, etc., and a signature box 78 or entry form to permit the user to ratify agreement 77 by signing it electronically. As mentioned above, agreement 77 may require signatures from multiple parties, such as the prospective renter, the owner/agent and the mortgagee, or the owner/agent and mortgagee may pre-authorize the agreement. In some embodiments, such as when the portal provides the financial services to pay the mortgagee, it is possible that the mortgagee is not a party to the agreement, depending on laws of the local jurisdiction and the manner by which payment is made to the mortgagee.

In each of the embodiments described above, it is or may be necessary to secure various permissions by the parties to the display of information, and such agreements may be part of the agreements described above, or may form part of the agreements entered into when the different users set up their accounts or otherwise enter into a relationship with the portal. Since some of the information that may be displayed involves sensitive financial data, all such information is presumed agreed to in some form before the display of the various data is provided via the web portal.

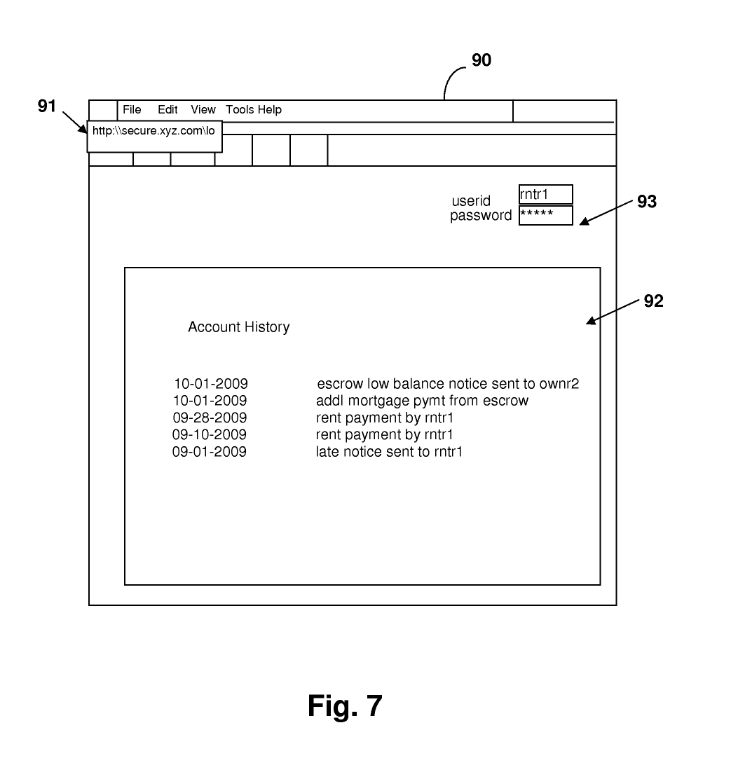

Referring now to FIG. 7, a transparent history feature of the present invention is shown in an output display 90 of a browser, which may be a browser of the renter, owner or mortagee. While a uniform interface is illustrated, the information presented in output display 90 might be tailored for the particular type of user accessing the screen, in order to maintain some of the information as private among some of the user types. For example, the mortgagee and the owner may be able to see the outstanding loan balance, as well as the payment and event history 92 depicted in the illustration, while the renter may only see the payment and event history 92. A login 93 user interface is used to secure the site pointed to by URL 91, which is a secure site, unlike the search screens, which might be secured by membership requirements, but which may be publicly available.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A computer-performed method for managing a relationship between a renter and at least one other party, the method comprising:
listing a property for rent by an owner of a property or the owner's agent in a display of a computer system;
receiving a first user input from a prospective renter selecting a property;
receiving a second user input from the prospective renter indicating an agreement to rent the property;
transmitting a notification to the owner of the property or the owner's agent that the prospective renter has agreed to rent the property;
receiving a third user input from the owner of the property or the owner's agent that the prospective renter is authorized to direct rents on the property to a mortagee of the property; and
storing an indication of an agreement between the prospective renter and the owner of the property resulting from the receiving the second user input and the receiving the third user input in a storage of the computer system.

2. The computer-performed method of claim 1, wherein the third user input is received subsequent to the notifying, wherein the owner or the owner's agent is required to respond in order to authorize the prospective renter to direct rents on the property to the mortgagee.

3. The computer-performed method of claim 1, wherein the third user input is received prior to the notifying, wherein the owner or the owner's agent has previously authorized any prospective renter to direct rents on the property to the mortgagee.

4. The computer-performed method of claim 1, further comprising:
collecting survey information about the performance of the prospective renter from the owner or the owner's agent; and
displaying results of the survey information to another property owner or agent, whereby a rating of the performance of the prospective renter is obtained by the another property owner or agent.

5. The computer-performed method of claim 1, further comprising:
collecting survey information about the performance of the owner or the owner's agent from a previous renter; and
displaying results of the survey information to the prospective renter, whereby a rating of the performance of the owner or owner's agent is obtained by the prospective renter.

6. The computer-performed method of claim 1, further comprising transmitting a notification to the mortgagee that the prospective renter will be directly paying mortgage payments to the mortgagee.

7. The computer-performed method of claim 1, wherein the prospective renter directs rents to the mortgagee by paying a service provider, wherein the service provider pays the mortgagee and pays the owner or owner's agent any excess upon receipt of the rents from the prospective renter.

8. A networked computer system comprising a processor for executing program instructions and a memory for storing the program instructions, wherein the program instructions are program instructions for implementing a network portal for managing a relationship between a renter and at least one other party, the program instructions comprising program instructions for:
listing a property for rent by an owner of a property or the owner's agent in a display coupled to the networked computer system;
receiving a first user input from a prospective renter selecting a property;
receiving a second user input from the prospective renter indicating an agreement to rent the property;
transmitting a notification to the owner of the property or the owner's agent that the prospective renter has agreed to rent the property;
receiving a third user input from the owner of the property or the owner's agent that the prospective renter is authorized to direct rents on the property to a mortagee of the property; and
storing an indication of an agreement between the prospective renter and the owner of the property resulting from the receiving the second user input and the receiving the third user input in a storage of the networked computer system.

9. The networked computer system of claim 8, wherein the program instructions for receiving third user input receive the third user input subsequent to executing the program instructions for notifying, wherein the owner or the owner's agent is required to respond in order to authorize the prospective renter to direct rents on the property to the mortgagee.

10. The networked computer system of claim 8, wherein the program instructions for receiving the third user input receive the third user input prior to executing the program instructions for notifying, wherein the owner or the owner's agent has previously authorized any prospective renter to direct rents on the property to the mortgagee.

11. The networked computer system of claim 8, wherein the program instructions further comprise program instructions for:
collecting survey information about the performance of the prospective renter from the owner or the owner's agent; and
displaying results of the survey information to another property owner or agent, whereby a rating of the performance of the prospective renter is obtained by the another property owner or agent.

12. The networked computer system of claim 8, wherein the program instructions further comprise program instructions for:
collecting survey information about the performance of the owner or the owner's agent from a previous renter; and
displaying results of the survey information to the prospective renter, whereby a rating of the performance of the owner or owner's agent is obtained by the prospective renter.

13. The networked computer system of claim 8, wherein the program instructions further comprise program instructions for transmitting a notification to the mortgagee that the prospective renter will be directly paying mortgage payments to the mortgagee.

14. The networked computer system of claim 8, further comprising program instructions for managing payment of rents from the prospective renter to a service provider, wherein the service provider pays the mortgagee and pays the owner or owner's agent any excess upon receipt of the rents from the prospective renter.

15. A computer-program product comprising program instructions for execution by a networked computer system, wherein the program instructions are program instructions for implementing a network portal for managing a relationship between a renter and at least one other party, the program instructions comprising program instructions for:
listing a property for rent by an owner of a property or the owner's agent in a display coupled to the networked computer system;
receiving a first user input from a prospective renter selecting a property;
receiving a second user input from the prospective renter indicating an agreement to rent the property;
transmitting a notification to the owner of the property or the owner's agent that the prospective renter has agreed to rent the property;
receiving a third user input from the owner of the property or the owner's agent that the prospective renter is authorized to direct rents on the property to a mortagee of the property; and
storing an indication of an agreement between the prospective renter and the owner of the property resulting from the receiving the second user input and the receiving the third user input in a storage of the networked computer system.

16. The computer program product of claim 15, wherein the program instructions for receiving third user input receive the third user input subsequent to executing the program instructions for notifying, wherein the owner or the owner's agent is required to respond in order to authorize the prospective renter to direct rents on the property to the mortgagee.

17. The computer program product of claim 15, wherein the program instructions for receiving the third user input receive the third user input prior to executing the program instructions for notifying, wherein the owner or the owner's agent has previously authorized any prospective renter to direct rents on the property to the mortgagee.

18. The computer program product of claim 15, wherein the program instructions further comprise program instructions for:
collecting survey information about the performance of the prospective renter from the owner or the owner's agent; and
displaying results of the survey information to another property owner or agent, whereby a rating of the performance of the prospective renter is obtained by the another property owner or agent.

19. The computer program product of claim 15, wherein the program instructions further comprise program instructions for:
collecting survey information about the performance of the owner or the owner's agent from a previous renter; and
displaying results of the survey information to the prospective renter, whereby a rating of the performance of the owner or owner's agent is obtained by the prospective renter.

20. The computer program product of claim 15, wherein the program instructions further comprise program instructions for transmitting a notification to the mortgagee that the prospective renter will be directly paying mortgage payments to the mortgagee.

21. The computer program product of claim 15, further comprising program instructions for managing payment of rents from the prospective renter to a service provider, wherein the service provider pays the mortgagee and pays the owner or owner's agent any excess upon receipt of the rents from the prospective renter.

22. A computer-performed method for managing a relationship between a renter and at least one other party, the method comprising:
listing a property for rent by an owner of a property or the owner's agent in a display of a computer system;
receiving a first user input from a prospective renter selecting a property;
receiving a second user input from the prospective renter indicating an agreement to rent the property;
transmitting a notification to the owner of the property or the owner's agent that the prospective renter has agreed to rent the property;
storing an indication of an agreement between the prospective renter and the owner of the property resulting from the receiving the second user input in a storage of the computer system;
collecting survey information about the performance of at least one of the renter, the owner or the owner's agent; and
displaying results of the survey information to another party, whereby a rating of the performance is obtained by the another party.

23. The computer-performed method of claim 22, wherein the collecting survey information collects survey information about the performance of the renter, and wherein the displaying displays the results of the survey information to another property owner or agent.

24. The computer-performed method of claim 22, wherein the collecting survey information collects survey information about the performance of the owner or owner's agent, and wherein the displaying displays the results of the survey information to another prospective renter.

25. A networked computer system comprising a processor for executing program instructions and a memory for storing the program instructions, wherein the program instructions are program instructions for implementing a network portal for managing a relationship between a renter and at least one other party, the program instructions comprising program instructions for:
listing a property for rent by an owner of a property or the owner's agent in a display coupled to the networked computer system;
receiving a first user input from a prospective renter selecting a property;
receiving a second user input from the prospective renter indicating an agreement to rent the property;
transmitting a notification to the owner of the property or the owner's agent that the prospective renter has agreed to rent the property;
storing an indication of an agreement between the prospective renter and the owner of the property resulting from the receiving the second user input in a storage of the networked computer system;
collecting survey information about the performance of at least one of the renter, the owner or the owner's agent; and
displaying results of the survey information to another party, whereby a rating of the performance is obtained by the another party.

26. The networked computer system of claim 25, wherein the program instructions for collecting survey information collect survey information about the performance of the renter, and wherein the program instructions for displaying display the results of the survey information to another property owner or agent.

27. The networked computer system of claim 25, wherein the program instructions for collecting survey information collect survey information about the performance of the owner or owner's agent, and wherein the program instructions for displaying display the results of the survey information to another prospective renter.

28. A computer program product comprising program instructions for execution in a networked computer system, wherein the program instructions are server program instructions for implementing a network portal for managing a relationship between a renter and at least one other party, the program instructions comprising program instructions for:
listing a property for rent by an owner of a property or the owner's agent in a display coupled to the networked computer system;
receiving a first user input from a prospective renter selecting a property;
receiving a second user input from the prospective renter indicating an agreement to rent the property;
transmitting a notification to the owner of the property or the owner's agent that the prospective renter has agreed to rent the property;
storing an indication of an agreement between the prospective renter and the owner of the property resulting from the receiving the second user input in a storage of the networked computer system;
collecting survey information about the performance of at least one of the renter, the owner or the owner's agent; and
displaying results of the survey information to another party, whereby a rating of the performance is obtained by the another party.

29. The computer program product of claim 28, wherein the program instructions for collecting survey information collect survey information about the performance of the renter, and wherein the program instructions for displaying display the results of the survey information to another property owner or agent.

30. The computer program product of claim 28, wherein the program instructions for collecting survey information collect survey information about the performance of the owner or owner's agent, and wherein the program instructions for displaying display the results of the survey information to another prospective renter.
